(19) United States
(12) Patent Application Publication
(10) Pub. No.: US 2025/0178293 A1
(43) Pub. Date: Jun. 5, 2025

(54) METHOD FOR MANUFACTURING A MULTI-PERFORATED COMPOSITE ACOUSTIC SKIN WITHOUT MECHANICAL PIERCING

(71) Applicant: SAFRAN NACELLES, GONFREVILLE L'ORCHER (FR)

(72) Inventors: Benjamin PROVOST, MOISSY-CRAMAYEL (FR); Fabrizio PAGANO, MOISSY-CRAMAYEL (FR); Bertrand Léon Marie DESJOYEAUX, MOISSY-CRAMAYEL (FR); Pierre-Yves GINI, MOISSY-CRAMAYEL (FR)

(21) Appl. No.: 18/965,065

(22) Filed: Dec. 2, 2024

(30) Foreign Application Priority Data
Dec. 1, 2023 (FR) 2313444

(51) Int. Cl. B29C 70/08; B29K 105/10

(52) U.S. Cl. CPC B29C 70/085; B29K 2105/101; B29K 2995/0001

(57) ABSTRACT

A method for manufacturing a multi-perforated acoustic skin out of composite material for an acoustic attenuation structure, the method including forming a fibrous preform including a matrix precursor material, carrying out a heat treatment for transforming the precursor into a matrix so as to obtain a multi-perforated acoustic skin made of composite material including a fibrous reinforcement densified by the matrix, the forming of the fibrous preform including draping fibers on a surface of a mandrel including protuberances, and the mandrel and the protuberances can be each made of a material that melts at a temperature lower than the heat-treatment temperature for transforming the precursor into a matrix in such a way as to eliminate the mandrel and the protuberances during the transforming heat treatment step.

### CROSS-REFERENCE TO RELATED APPLICATIONS

This application claims priority to French Patent Application No. 2313444, filed Dec. 1, 2023, the entire content of which is incorporated herein by reference in its entirety

### FIELD

The present invention relates to the general field of acoustic attenuation structures. It relates, more particularly, to acoustic skins made of composite material included in the acoustic attenuation structures.

### BACKGROUND

Multi-perforated acoustic skins made of composite material are used to absorb noise in a certain acoustic frequency range in engines, and in particular at the gas turbines or exhaust thereof.

In certain methods of the prior art, multi-perforated acoustic skins made of composite material are produced by piercing and machining numerous small holes through the skin made of composite material. These methods generally involve piercing these holes manually one by one, or mechanically using a mat having spikes, which involves a very long preparation time. This technique is used, in particular, to pierce holes of diameter between 1 millimeter and several millimeters.

Other manufacturing methods of multi-perforated acoustic skins made of composite material include a step of piercing the skin after the step of consolidating the composite material. Documents U.S. Pat. No. 6,190,602 and EP3590843 are known in this respect. Document U.S. Pat. No. 6,190,602 proposes depositing the composite material obtained following the consolidation step on a support and inserting a foldable piercing device having spikes or nails, through the assembly comprising said composite material and the support. This step is followed by the removal of the piercing device. Document EP3590843 proposes a method in which inserts are manually introduced into a layer of the composite material obtained following the consolidation step. This step is followed, as in the preceding case, by removing some of the inserts.

Other methods from the prior art propose incorporating the forming of the perforations during the forming of the preform. Such is the case for document CN211975529, which proposes draping, in different directions, a surface with a plurality of layers of fibrous reinforcements so as to form perforations, into which spikes are introduced. Furthermore, document WO2017017367, proposes a method for manufacturing an acoustic panel having a sandwich structure. In this case, draping on a mold with a first layer of plies consisting of fibrous reinforcements is carried out, and on this rounded blocks each having spikes made of meltable material are disposed. A second layer of plies is deposited on these blocks. Perforations of the second layer are obtained as well as cells between the two layers during the densification step.

However, all of these methods are inefficient for various reasons. Manufacturing methods implementing piercing or perforation steps require the use of particularly expensive piercing or cutting tools. Moreover, the tools for forming such perforations generally have drill bits or spikes requiring frequent replacement.

The disadvantage of the other methods is to require the implementation of numerous steps and to cause very slow depositing of the material, which represents a significant economic cost.

### SUMMARY

One or more aspects of the present invention are therefore to propose a solution for the manufacture of a multi-perforated acoustic skin made of composite material which does not have the above-mentioned disadvantages.

For this purpose, an aspect of the invention proposes a method for manufacturing a multi-perforated acoustic skin made of composite material for an acoustic attenuation structure, the method including the following steps:
forming a fibrous preform comprising a matrix precursor material,
carrying out a heat treatment for transforming the precursor into a matrix so as to obtain a multi-perforated acoustic skin made of composite material comprising a fibrous reinforcement densified by said matrix,
wherein the step of forming the fibrous preform includes draping fibers on a surface of a mandrel comprising protuberances, and wherein the mandrel and the protuberances can each be made of a material that melts at a temperature lower than the heat-treatment temperature for transforming the precursor into a matrix in such a way as to eliminate said mandrel and said protuberances during the transforming heat treatment step.

Thus, the manufacturing method makes it possible to obtain multi-perforated acoustic skins made of composite material which do not require mechanical piercing or machining or the use of specific tools, which are long and expensive to implement. An aspect of the method of the invention therefore enables a more economic manufacture of multi-perforated acoustic skins compared with the manufacturing solutions of the prior art. An aspect of the method of the invention further enables manufacturing of multi-perforated acoustic skins having complex shapes, and more particularly acoustic skins for annular shaped parts. An aspect of the method according to the invention also enables reduction in the manufacturing time of the skins because the elimination of the mandrel and the protuberances, and the densification of the composite material, can be carried out during the same step.

The term “meltable material” shall mean a material that is capable of being eliminated under the effect of heat during the heat treatment for transforming the precursor into a matrix.

According to a particular feature of the method, the step of forming the preform can include draping dry fibers on the surface of the mandrel followed by a step of impregnating the fibrous preform with the matrix precursor material.

According to another particular feature of the method, the step of forming the preform can include draping fibers pre-impregnated with the matrix precursor material on the surface of the mandrel.

According to a particular feature of the method, the draping with fibers can be carried out by winding of fibers. The winding of fibers makes it possible to obtain materials with very good mechanical properties, as well as disposing the fibers optimally in the direction of the forces to be supported.

The term “winding of fibers” shall mean a method which can include a step consisting of winding fibers on a mandrel or a rotating mold.

According to another particular feature of the method, the winding of fibers can be carried out with a winding angle greater than or equal to 7° with respect to a central axis of the mandrel. Such a value of the winding angle makes it possible to wind the fiber in a precise manner in the axis of the mandrel.

According to another particular feature of the method, the draping of fibers can be carried out by automated fiber placement (AFP). The automated fiber placement can optimally dispose the fibers on very complex geometries and therefore obtain parts having complex geometries with very good mechanical properties.

According to another particular feature of the method, the draping can be carried out with unidirectional ribbons of fibers or strips of fibers.

According to another particular feature of the method, the multi-perforated skin can be made of an organic matrix composite material (OMC).

It is thus possible to obtain a multi-perforated skin which has good resistance to fatigue and to corrosion role being lightweight and economic.

According to another particular feature of the method, the multi-perforated skin can be made of a ceramic matrix composite material (CMC). In this way, it is possible to obtain a multi-perforated skin which has a very high resistance to temperature and with very good mechanical properties.

According to another particular feature of the method, the impregnating of the fibrous preform can be carried out with a solution filled with particles of the matrix precursor material and the transforming heat treatment step can include a sintering step.

According to another particular feature of the method, the mandrel and the protuberances can be made of the same material.

According to another particular feature of the method, the mandrel can be made of a first meltable material and the protuberances can be made of a second meltable material. In such a configuration, it is possible to eliminate the protuberances and the mandrel at different moments of the method. Such a method may be the most beneficial when it is desired to ensure optimal shaping of the perforations. In this case, the meltable material of the protuberances can be eliminated after the elimination of the mandrel, thus enabling a prolonged shaping of the protuberances. Consequently, perforations with better precision of the diameter can be obtained.

According to another particular feature of the method, the second meltable material can be deformable. Thus, the protuberances can be deformed under the effect of positioning an envelope or a counter-mold around the mandrel. It is consequently possible to be able to optimally managed the thickness of the finished part during the transforming heat treatment step.

Another aspect of the invention also relates to a mandrel for implementing the method for manufacturing a multi-perforated acoustic skin made of composite material for an acoustic attenuation structure, wherein the mandrel includes protuberances, and wherein the mandrel and the protuberances are each made of a material that melts at a temperature lower than the temperature of the heat treatment for transforming the precursor into a matrix. Thus, it is possible to eliminate the mandrel and the protuberances, and to carry out the densification of the composite material during the same step. Moreover, this makes it possible to avoid any piercing, machining and removal step, which can be delicate and require a long time to implement.

### BRIEF DESCRIPTION OF THE DRAWINGS

Other features and benefits of the present invention will become apparent from the description given below, with reference to the appended drawings which illustrate exemplary embodiments that are in no way limiting.

FIG. 1 is a flowchart of the steps of a method for manufacturing a multi-perforated acoustic skin out of composite material in accordance with an embodiment of the invention;

FIG. 2 is a schematic perspective view of the implementation of a fiber draping step, carried out by winding fibers in accordance with an embodiment of the invention;

FIG. 3 is a schematic perspective view of the implementation of an impregnation step according to an embodiment of the invention; and

FIG. 4 is a schematic perspective view of a transforming heat treatment step according to an embodiment of the invention.

### DETAILED DESCRIPTION

Various aspects of the invention apply in general to the manufacture of multi-perforated skins out of composite material intended to be used in acoustic attenuation structures present in aeronautical engines.

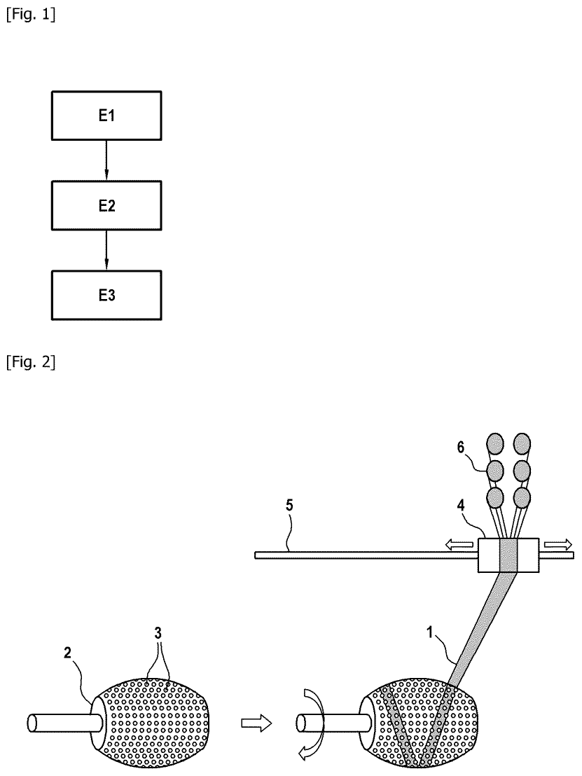

According to an embodiment of the method of the invention described in FIG. 1, the manufacture of a multi-perforated acoustic skin out of composite material for an acoustic attenuation structure according to the invention starts by forming a fibrous preform (step E1) by draping fibers 1 on a surface of a mandrel 2 comprising protuberances 3. The mandrel 2 constitutes a mold for the formation of the fibrous preform. The mandrel can, in particular, be rotatable about its central axis.

According to another particular feature of the method, the draping can be carried out with unidirectional ribbons of fibers or strips of fibers.

When the draping is carried out with unidirectional ribbons, a plurality of parallel ribbons can be disposed simultaneously. By contrast, when the draping is carried out with strips, the strips can be disposed one by one.

According to a particular feature of the method, the unidirectional ribbons can have a width less than or equal to 10 mm.

According to a particular feature of the method, the strips can have a width between 10 and 200 mm.

The unidirectional ribbons of fibers or the strips of fibers used for the draping can be formed of “dry” fibers, that is to say devoid of matrix precursor or fibers pre-impregnated with a matrix precursor. In the case of dry fibers, the fibrous preform is impregnated with a matrix precursor after draping.

The protuberances 3 can have a cylindrical-conical or conical or pointed shape, or else a combination of two shapes.

The mandrel 2 and the protuberances 3 are each made of a material that melts at a temperature lower than the temperature of the heat-treatment carried out during the transformation of the matrix precursor.

The mandrel 2 can be formed, as in the example described here, as a single part. Alternatively, it can be formed of at least two parts assembled together.

The multi-perforated skin according to an embodiment of the invention can be made from thermostructural composite material, in other words a composite material having good mechanical properties and an ability to maintain these properties at high temperature. Typical thermostructural composite materials are ceramic matrix composite materials (CMC). Examples of CMC are C/SiC composites (carbon fiber reinforcements and silicon carbide matrix), C/C-SiC composites (carbon fiber reinforcements and matrix including a carbon phase, generally closest to the fibers, and a silicon carbide phase), SiC/SiC composites (reinforcement fibers and silicon carbide matrix) and oxide/oxide composites (reinforcement fibers and an aluminous alumina matrix).

The multi-perforated skin according to an embodiment of the invention can also be made of organic matrix composite material (OMC). These materials are formed of a fiber reinforcement embedded in a consolidated or hardened organic matrix. They have the benefit of having excellent mechanical properties and good corrosion resistance, while being lightweight. The matrix of OMC materials can include polymer resins. These resins can be present in a non-polymerized state in liquid and viscous form. The reinforcements can be, for example, glass fibers, carbon fibers or aramid fibers (Kevlar®).

The one or more materials of the mandrel 2 and protuberances 3 are chosen by taking into account the temperature of the heat treatment for transforming the precursor into a matrix. The melting temperature of the one or more materials of the mandrel and protuberances is less than the temperature defined for the transforming heat treatment. In the case, in particular, of the manufacture of an acoustic skin out of organic matrix composite (OMC), the meltable material of the mandrel 2 and that of the protuberances 3 each have a melting temperature less than or equal to 300° C. In the case of the manufacture of an acoustic skin out of thermostructural composite material (CMC), the melting temperature of each of the materials of the mandrel 2 and protuberances 3 is between 350° C. and 1000° C. Thus, it is possible to eliminate the mandrel 2 and the protuberances 3 at a temperature lower than that of the heat treatment, but also to ensure cohesion of the fibers 1 of the preform with the matrix before elimination of the mandrel 2 and protuberances 3.

According to a particular feature of the method and of the mandrel, the meltable material of the mandrel and/or the meltable material of the protuberances can be chosen from: plastics or metal alloys. The metal alloys can include aluminum alloys, tin alloys, zinc alloys or a mixture thereof.

According to a particular feature of the method and of the mandrel, the meltable material of the mandrel and/or the meltable material of the protuberances can be a plastic having a melting temperature between 100° C. and 500° C.

According to a particular feature of the method and of the mandrel, the meltable material of the mandrel can be a plastic and the meltable material of the protuberances can be a metal alloy.

The draping step can be carried out by various techniques such as: winding of fibers, automated fiber placement (AFP) or else manual draping, or a combination of two or more of these techniques. The application of a predetermined tension on the fibers 1 may be needed in order to guarantee that these optimally match the surface of the mandrel 2.

FIG. 2 shows draping by winding of fibers. In the exemplary embodiment of FIG. 2, a winding head 4 disposes fibers 1, which can be subjected to a predetermined tension, in contact with the surface of the mandrel 2. While the winding head 4 carries out this draping, the mandrel 2 can turn about its central axis. During the draping step, the winding head 4 can move along a movement rail 5. The term “movement rail” shall mean an element serving to guide the movements of the winding head 4. The fibers 1 can, for example, be picked up by the winding head 4 from a bobbin of fibers 6, as illustrated in FIG. 2.

The draping can also be carried out by automated fiber placement. During use of this draping technique, a robot comprising a placement head can automatically dispose the fibers 1 in contact with the surface of the mandrel 2 in order to drape this (not shown).

The draping of fibers can be carried out along predetermined orientations with respect to a central axis of the mandrel. The winding of fibers can be carried out parallel to a central axis of the mandrel. At the end of the draping step, a fibrous preform (not-shown) can be obtained.

Once the preform is produced, the densification of the fibrous preform then follows in order to form a part made of composite material by heat treatment thereof, in order to transform the precursor into matrix.

In the case of draping with dry fibers on the surface of the mandrel 2, the fibers 1 can comprise a binder. Thus, it is possible to maintain the fibers and the layers of fibers connected together during the draping step. In this case, the binder used has a different composition from the precursor material of the matrix, so as to be eliminated during a step which precedes the impregnating of the preform with a matrix precursor and the heat treatment for transforming the precursor into a matrix.

The densification of the fibrous preform intended to form the fibrous reinforcement of the part to be manufactured consists of filling the pores of the preform, in all or part of the volume thereof, with the material constituting the matrix.

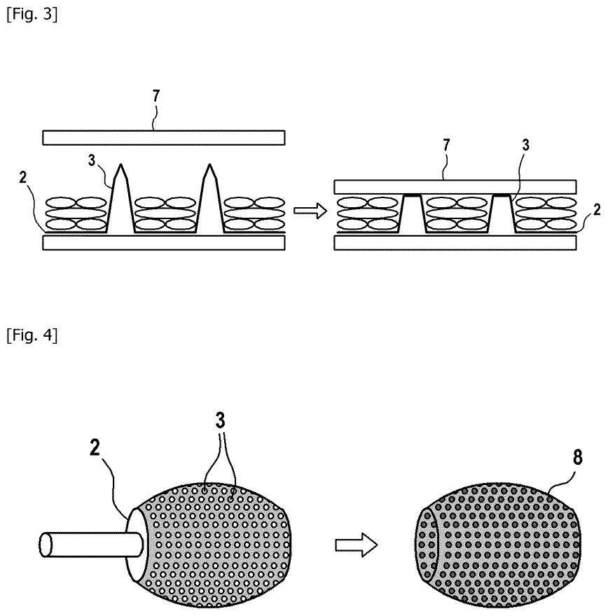

The step of heat treatment for transforming the precursor into a matrix can be preceded by a step during which an envelope or a counter-mold 7 is disposed around the mandrel 2, the space formed between the envelope and the surface of the mandrel defining the thickness of the part. The envelope can be disposed in contact with the protuberances 3 of the mandrel 2. According to an alternative embodiment illustrated in FIG. 3, the protuberances 3 and the mandrel 2 can be made of different meltable materials. The meltable material of the protuberances can be deformable, such as polypropylene or low-density polyethylene. Thus, when the inner surface of the envelope 7 is disposed in contact with the protuberances 3, the latter can be deformed as illustrated on the right of the FIG. 3. This makes it possible to optimally manage the thickness of the skin by compaction during the impregnation step.

In the context of the manufacturing of a multi-perforated acoustic skin made of OMC, the matrix precursor present on the pre-impregnated fibers, or used to impregnate the fibrous preform after the draping of dry fibers, corresponds to a liquid composition containing an organic precursor of the matrix material. The organic precursor usually has the form of a polymer, such as a resin, optionally diluted in a solvent. Examples of resins are: polyester resins, epoxy resins and phenolic resins.

In the case of draping with dry fibers, the impregnating of the fibrous preform can be carried out in a manner known per se according to the liquid method (CVL) or else by impregnating by resin transfer molding (RTM). The liquid method involves impregnating the preform with a liquid composition containing a precursor of the matrix material. The precursor is usually in the form of a polymer, such as a high-performance epoxy resin, optionally diluted in a solvent.

In the case of the manufacture of a multi-perforated skin out of thermostructural composite material (CMC), the matrix precursor present on the pre-impregnated fibers, or used to impregnate the fibrous preform after the draping of dry fibers, corresponds to a liquid composition containing a ceramic material precursor (step E2) In the case of draping with dry fibers, the fibrous texture can be impregnated in a bath containing the resin and usually a solvent thereof.

Other known impregnation techniques can be used, such as passage of the fibrous texture through a continuous impregnator, impregnation by infusion, impregnation by resin transfer molding (RTM), impregnation by injection of a ceramic filler (slurry cast) or by a silicon alloy impregnation method (MI or RMI) or again by following a sequence of one or more of these methods.

In certain embodiments, the impregnation step can be carried out with a solution filled with matrix precursor material particles, in particular for the manufacture of multi-perforated acoustic skins out of CMC. In this case, a filled solution or slip is injected under pressure into the preform.

The filled solution can, for example, be a suspension of an alumina powder in an aqueous solution.

More generally, the filled solution can be a suspension including refractory ceramic particles having a particular average dimension between 0.1 μm and 10 μm. The content by volume of refractory ceramic particles in the slip before injection, can be between 15% and 40%. The refractory ceramic particles can comprise a material chosen from: alumina, mullite, silica, aluminosilicates, aluminophosphates, carbides, borides, nitrides and the mixtures of these materials.

The medium or liquid phase of the solution can include, for example, an aqueous phase having an acid pH (i.e. a pH less than 7) and/or an alcohol phase including ethanol, for example. The slip can include an acidifier such as nitric acid and the pH of the liquid medium can be, for example, between 1.5 and 4.5. The slip can further include an organic binder such as polyvinyl alcohol (PVA) which is, in particular, soluble in water.

The medium or liquid phase can be drained out of the preform, enabling a deposition by sedimentation of the ceramic particles in the preform.

In this case, the mandrel 2 includes an outer layer, in contact with the porous fibrous preform. This allows for an infiltration with flow transverse to the thickness, promoting the accumulation of powder within the fibrous preform. The liquid medium of slip being evacuated through the porous mandrel 2. This porous layer of mandrel can be obtained by partial sintering of granules or powder of a material, for example plastic, or by bonding together of material granules. The protuberances 3 can be of a solid plastic or metal material implanted in the mandrel 2 by pegging.

Once the injection and drainage steps have been performed, a fibrous preform is obtained filled with refractory ceramic particles, for example refractory ceramic oxide or alumina particles.

The method continues via a heat treatment for transforming the precursor into a matrix (step E3, FIG. 1). It should be noted that the mandrel and the protuberances are eliminated during step E3 (FIG. 4). FIG. 4 also shows a multi-perforated skin 8 which can be obtained after the heat treatment according to step E3.

In the case, in particular, of the manufacture of an acoustic skin out of OMC, the heat treatment for transforming the precursor into a matrix, namely its polymerization, is generally carried out at a temperature between 90° C. and 380° C.

The transforming heat treatment in the context of the manufacture of a composite material out of OMC is also known as “curing”.

In the case, in particular, of the formation of a ceramic matrix, the heat treatment consists of pyrolysing the precursor in order to transform the matrix into a carbon or ceramic matrix depending on the precursor used and the pyrolysis conditions. By way of example, ceramic liquid precursors, in particular SiC or SiCN, can be polycarbosilane (PCS) polytitanocarbosilane (PTCS) or polysilazane (PSZ) resins, whereas carbon liquid precursors can be resins with a relatively high coke content, such as phenolic resins. Several consecutive cycles can be carried out from the impregnation up to the heat treatment, in order to achieve the desired degree of densification.

In the case of an impregnation with a solution filled with refractory ceramic particles, the filled preform is subjected to a sintering heat treatment, for example in air at a temperature between 1000° C. and 1200° C., in order to sinter the refractory ceramic particles and thus form a refractory ceramic matrix in the pores of the fibrous preform. Thus, a multi-perforated acoustic skin is obtained, made of composite material, for example made of oxide/oxide composite material, provided with a fibrous reinforcement formed by the fibrous preform and having a high volume fraction for the matrix with a homogeneous distribution of the refractory ceramic matrix throughout the fibrous reinforcement.

A part made of composite material CMC other than oxide/oxide type can be obtained in the same way by producing the fibrous texture with silicon carbide and/or carbon fibers and by using a slip filled with particles of carbide (for example, SiC), boride (for example TiB2) or nitride (for example Si3N4).

The densification methods described above make it possible to produce, from the fibrous structure of the invention, mainly multi-perforated skins made of composite material with an organic matrix (CMO), carbon matrix and ceramic matrix (CMC). The organic matrix composite (OMC) and ceramic matrix composite (CMC) materials are replacing metal parts in certain sections of turbomachines. Their use contributes to optimizing the performance of aircraft, in particular by improving the efficiency of the turbomachine and reducing the overall mass of the turbomachine, significantly reducing emissions harmful for the environment (CO, CO2, NOX, etc.).

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

A person skilled in the art will readily appreciate that various features, elements, aspects, parameters disclosed in the description may be modified and that various embodiments disclosed may be combined without departing from the scope of the invention. For example, various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be aspects of this disclosure. Accordingly, the foregoing description and drawings are by way of example only.

1. A method for manufacturing a multi-perforated acoustic skin out of composite material for an acoustic attenuation structure, said method comprising the following steps:
forming a fibrous preform including a matrix precursor material,
carrying out a heat treatment for transforming the precursor into a matrix so as to obtain a multi-perforated acoustic skin made of composite material including a fibrous reinforcement densified by said matrix,
wherein the step of forming the fibrous preform includes draping fibers on a surface of a mandrel comprising protuberances, and wherein the mandrel and the protuberances can each be made of a material that melts at a temperature lower than the heat-treatment temperature for transforming the precursor into a matrix, in such a way as to eliminate said mandrel and said protuberances during the transforming heat treatment step.

2. The method according to claim 1, wherein the step of forming the preform includes draping dry fibers on the surface of the mandrel followed by a step of impregnating the fibrous preform with the matrix precursor material.

3. The method according to claim 1, wherein the step of forming the preform includes draping fibers pre-impregnated with the matrix precursor material on the surface of the mandrel.

4. The method according to claim 1, wherein the draping with fibers is carried out by winding fibers.

5. The method according to claim 4, wherein the winding of fibers is carried out with a winding angle greater than or equal to 7° with respect to a central axis of the mandrel.

6. The method according to claim 1, wherein the draping of fibers is carried out by automated fiber placement.

7. The method according to claim 1, wherein the draping is carried out with unidirectional ribbons of fibers or strips of fibers.

8. The method according to claim 1, wherein the multi-perforated skin is made of an organic matrix composite material.

9. The method according to claim 1, wherein the multi-perforated skin is made of a ceramic matrix composite material.

10. The method according to claim 9, wherein the step of forming the preform includes draping dry fibers on the surface of the mandrel followed by a step of impregnating the fibrous preform with the matrix precursor material and wherein the step of impregnating the fibrous preform is carried out with a solution filled with particles of the matrix precursor material and the transforming heat treatment step includes a sintering step.

11. The method according to claim 1, wherein the mandrel is made of a first meltable material and the protuberances are made of a second meltable material, said second meltable material being deformable.

12. A mandrel for implementing the method for manufacturing a multi-perforated acoustic skin made of composite material for an acoustic attenuation structure according to claim 1, wherein said mandrel includes protuberances, and wherein the mandrel and the protuberances are each made of a material that melts at a temperature lower than the temperature of the heat treatment for transforming the precursor into a matrix.
